(19) United States
(12) Patent Application Publication
(10) Pub. No.: US 2009/0320714 A1
(43) Pub. Date: Dec. 31, 2009

(54) MAGNETIC LEVITATION PROPULSION SYSTEM

(76) Inventor: Thomas E. Alberts, Virginia Beach, VA (US)

Correspondence Address: WILLIAMS MULLEN, 222 CENTRAL PARK AVENUE, SUITE 1700, VIRGINIA BEACH, VA, 23462, US

(21) Appl. No.: 12/493,767

(22) Filed: Jun. 29, 2009

Related U.S. Application Data
(60) Provisional application No. 61/133,359, filed on Jun. 27, 2008.

(51) Int. Cl. B60L 13/10; B61C 3/00

(52) U.S. Cl. 104/281; 105/49

(57) ABSTRACT

A system for propelling a vehicle in a desired direction using a linear induction motor situated proximate to, but off-board the vehicle. The linear induction motor has a suspension system adapted to suspend the motor a desired distance from a reaction rail, separate from any suspension system for the vehicle. The linear induction motor moves the vehicle using a generally rigid member extending between the linear induction motor and the vehicle. Application of a current to the stator of the motor communicates a desired force to the linear induction motor, the general rigid member, and the vehicle.

### CROSS-REFERENCE TO RELATED APPLICATION

This application claims the benefit of priority to U.S. App. Ser. No. 61/133,359, filed Jun. 27, 2008, titled Towing Linear Induction Motor for Transit Applications.

### FIELD OF THE INVENTION

The present invention relates to a propulsion system. In particular, the present invention is adapted for use with towed or driven vehicles, including in particular, a towing linear induction motor propulsion system for magnetic levitation (Maglev) vehicles suitable for use in transit systems.

### BACKGROUND OF THE INVENTION

Linear motors used in Maglev and other transit applications are generally either Linear Induction Motors (LIM) or Linear Synchronous Motors (LSM). LIMs are usually employed in the so-called “short stator” arrangement in which the motor primary or stator is short and vehicle mounted, while the motor secondary or reaction rail is passive and attached to or incorporated into the guideway along its full length. LSMs typically use a “Long Stator” arrangement, with a long motor primary is mounted on the guideway, while a short secondary is mounted on the vehicle. LIMs lead to a lower cost guideway, but a heavier and more expensive vehicle. LSMs lead to an expensive guideway, but offer a lighter, lower cost vehicle. It is generally accepted that LSMs are more efficient to operate.

The weight of vehicle mounted LIMS has been identified as a performance and efficiency problem. In particular for Maglev applications, the levitation system for such vehicles must be strong enough to overcome the additional weight of the LIM stator or primary, its power supply, and any control systems. Operationally, this renders vehicle mounted LIMS less efficient to operate. Further, a vehicle mounted LIM can produce design challenges in inter-relation with the magnetic levitation system. For example, levitation systems typically are directed to producing larger air gaps, while the efficiency of LIMS is improved with a smaller air gap.

Some approaches have employed LIMs installed within a track or guideway. As might be expected, however, such approaches erode the cost advantage for track or guideway construction adapted to support a Maglev vehicle having a vehicle mounted LIM. Accordingly, the main applications having LIMs installed within a track or guideway are cases that are functional with discrete propulsion over only a portion of the track, as with a roller coaster, for example.

### SUMMARY OF THE INVENTION

Accordingly, an aspect of the present invention is a system for propelling (i.e., towing or pushing) a vehicle in at least one desired direction.

In one embodiment, the vehicle may be configured to levitate magnetically with respect to a levitation surface. The system involves a linear induction motor situated proximate to, but off-board, the vehicle. The linear induction motor has a stator that defines a channel adapted to receive a supported reaction rail, with “support” connoting the ability to receive a reaction force. The rail extends in the desired direction. The motor also includes a suspension system adapted to suspend the stator at a desired distance from the reaction rail. A motor bus subsystem is provided in conductive communication with the linear induction motor, a power supply, and a control system. A generally rigid member extends between the linear induction motor and the vehicle. This member has a motor attachment end affixed to the motor and a vehicle attachment end affixed to the vehicle. At least one pivot is within the member, such that the vehicle and the linear induction motor may be suspended independently of each other during operation without carrying the weight of the other. Application of a current to the stator of the linear induction motor via the motor bus subsystem creates a desired force along the at least one desired direction. The general rigidity of the member is such that the desired force along the at least one desired direction is communicated to the linear induction motor, the general rigid member, and the vehicle, such that they are propelled in the at least one desired direction. The motor suspension system may include rollers, wheels, a secondary magnetic levitation system, an air cushion system, at least a portion of the stator, etc. Optionally, the member further comprises a shock absorber.

In some embodiments, attachment ends of the member comprise ball joints. Optionally, motor attachment end may be detachably affixed to the motor; optionally, the vehicle attachment end may be detachably affixed to the vehicle. In some cases, both attachment ends may be detachable. The power supply may be located off-board the vehicle, or on-board the vehicle. The control system may be located off-board the vehicle, or on-board the vehicle.

The vehicle is not necessarily a Maglev vehicle. In one embodiment, the system involves a linear induction motor situated proximate to, but off-board, the vehicle. The linear induction motor has a stator that defines a channel adapted to receive a supported reaction rail, with “support” connoting the ability to receive a reaction force. The rail extends in the desired direction. The motor also includes a motor suspension system adapted to suspend the stator at a desired distance from the reaction rail. A motor bus subsystem is in conductive communication with the linear induction motor, a control system, and a power supply. A generally rigid member extends between the linear induction motor and the vehicle. This member has a motor attachment end affixed to the motor and a vehicle attachment end affixed to the vehicle. At least one pivot is within the member, such that the vehicle and the linear induction motor may be suspended independently of each other during operation without carrying the weight of the other. Application of a current to the stator of the linear induction motor via the motor bus subsystem creates a desired force along the at least one desired direction. The general rigidity of the member is such that the desired force along the at least one desired direction is communicated to the linear induction motor, the general rigid member, and the vehicle, such that they are propelled in the at least one desired direction. The motor suspension system may include rollers, wheels, a motor magnetic levitation system, an air cushion system, at least a portion of the stator, etc. Optionally, the member further comprises a shock absorber.

In some embodiments, attachment ends of the member comprise ball joints. Optionally, motor attachment end may be detachably affixed to the motor; optionally, the vehicle attachment end may be detachably affixed to the vehicle. In some cases, both attachment ends may be detachable. The power supply may be located off-board the vehicle, or on-board the vehicle. The control system may be located off-board the vehicle, or on-board the vehicle.

### BRIEF DESCRIPTION OF THE DRAWINGS

The invention will be better understood in relation to the attached drawings illustrating preferred embodiments, wherein:

FIG. 1 is a front view of a prior art configuration of a Maglev vehicle with the guideway and LIM cross sections shown.

FIG. 2 is a front view of an embodiment of the invention with guideway and LIM cross sections shown.

FIG. 3 is a side view of an embodiment of the invention.

### DETAILED DESCRIPTION

An off-board LIM for a transportation system would enjoy some of the benefits of different approaches to propulsion. An aspect of this invention is that the LIM would be suspended (i.e., separately from vehicle suspension), either magnetically, by air cushion, or mechanically with respect to a dedicated, conductive passive reaction rail, which the LIM primary may wrap around. In some embodiments, a portion of the LIM stator may be used for suspension of the LIM. A wrap around design (sometimes referred to as tubular LIM) with motor suspension allows the LIM to have a very small air gap for increased efficiency. A separate, off-board LIM does not impose attractive or repulsive forces that could conflict with the forces of a primary suspension. The vehicle itself could be simpler than one carrying LIMs and the associated drive equipment. In one embodiment, the vehicle could be towed by a mechanical link attached to the LIM. Alternatively, the vehicle could be pushed by an off-board LIM.

The uses of this invention may thus include magnetically levitated transportation systems, other transit vehicles including rail systems or highway vehicles, amusement rides, and a wide variety of other transport embodiments. Some of the advantages of this invention include that it is more efficient than conventional LIM approaches, and enables a lower cost, lighter vehicle. In addition, the present invention is less expensive than the LSM approach. Full advantage of the off-board LIM approach is manifested in Maglev transportation system, so primary description is to Maglev embodiments; however, the invention should not be construed as limited thereto.

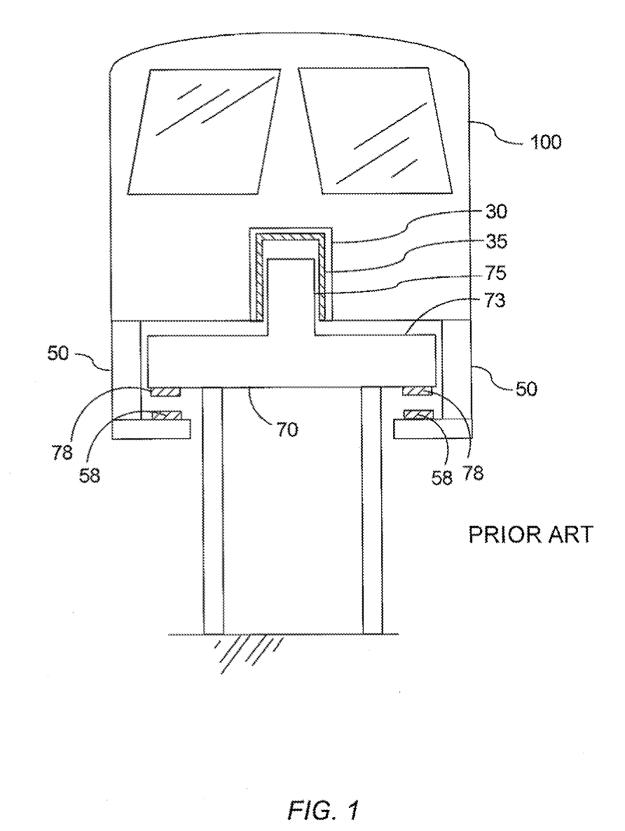

With reference to the drawings, FIG. 1 is an illustration of an embodiment of a magnetic levitation vehicle 100 using a prior or conventional approach for LIM propulsion. The perspective is a front view of the prior art configuration with guideway 70 and LIM 30 cross sections shown. Bogie 50 supports vehicle 100 magnets 58 that inter-relate with magnets 78 supported by guideway 70, forming a portion of the levitation system that enables the vehicle 100 to levitate magnetically above levitation surface 73 in a conventional manner. Guideway 70 also supports a passive, highly conductive reaction rail 75, which engages electromagnetically with stator 35 of LIM 30. Thus, in a conventional embodiment, vehicle 100 bears levitation power and control systems (not shown) as well as LIM 30 power and control systems (not shown). These can include elements such as direct current pickup from an energized rail, precharging resistors, inverters, etc.

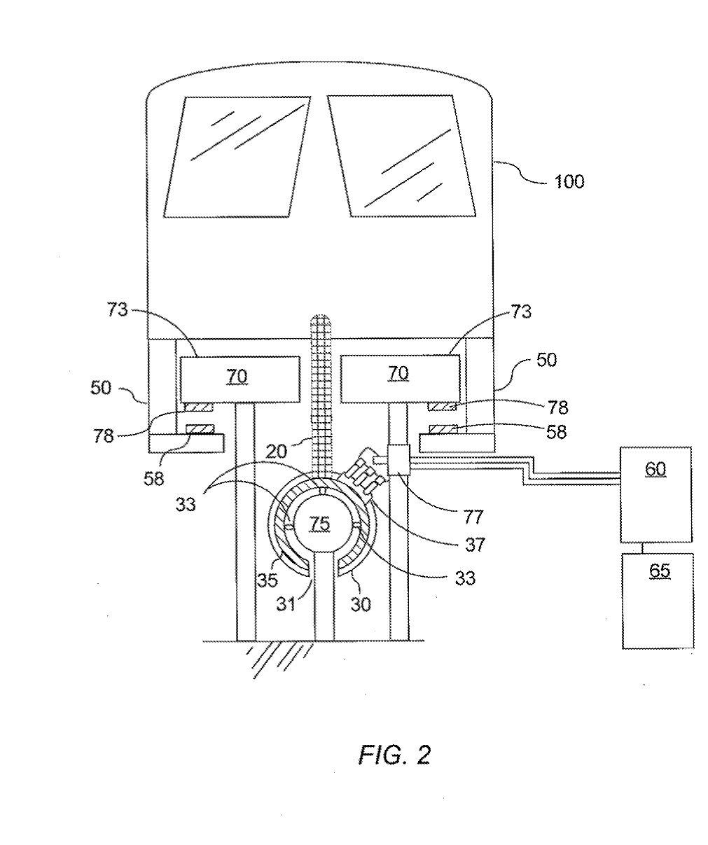

FIG. 2 is an illustration of an aspect of the present system for LIM propulsion of a magnetic levitation vehicle 100, for comparison with FIG. 1. This figure is also a front view with guideway 70 and LIM 30 cross section shown, such that the desired direction of motion is out of the page. LIM 30 is situated near or proximate to, but off-board, the magnetic levitation vehicle 100. The LIM 30 comprises a stator 35 defining a channel 31 adapted to receive a supported reaction rail 75, which may be separate from the levitation surface 73. The reaction rail 75 thus extends in the at least one desired direction. A motor suspension system 33 adapted to suspend the stator at a desired distance from the reaction rail 75. Motor suspension system may take any of a variety of embodiments, such as rollers, wheels, balls, a separate or secondary maglev system, or air cushioning systems.

A motor bus subsystem 37 in conductive communication with a power supply 77. In this embodiment, drive inverter 60 and control system 65 are shown off-board vehicle 100 and LIM 30. Elements of these components may be positioned on vehicle 100, if desired for the application; however, such positioning may increase the levitation weight born by vehicle 100 during levitation and the weight to be propelled, decreasing efficiency for Maglev vehicle applications. Elements of these components may optionally be positioned on LIM 30, which would avoid increasing the levitation weight, but still increasing weight to be propelled. In the embodiment shown, drive inverter 60 supplies three phase power to power supply 77, with motor bus subsystem 37 shown as three phase conductive roller pickup as well.

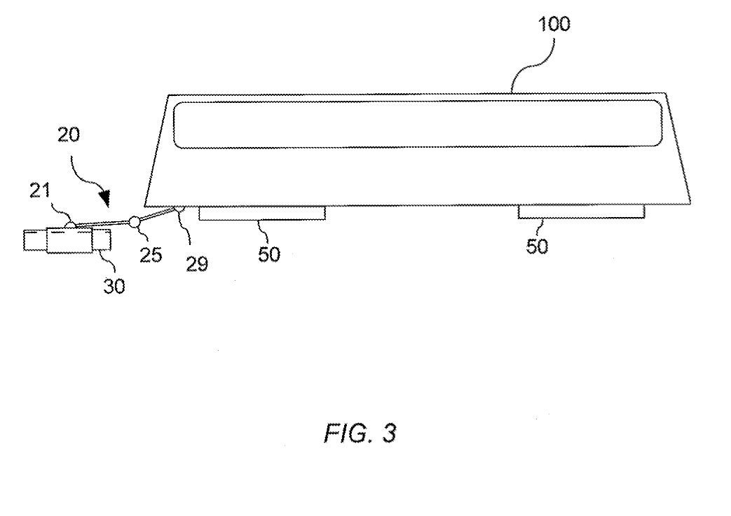

With respect to the side view of FIG. 3 of a towing embodiment system with a single LIM 30, a generally rigid member 20 extends between the LIM 30 and the vehicle 100. The term “generally rigid” in reference to member 20 is such that a desired force generated by LIM 30 against reaction rail 75 (not shown) along the at least one desired direction is communicated to the LIM 30, the generally rigid member 20, and the vehicle 100, such that they are all propelled in the at least one desired direction. Member 20 may take a variety of different forms, depending on the configuration of vehicle 100, guideway 70, reaction rail 75, and relative positioning of LIM 30 with respect to vehicle 100.

Member 20 has a motor attachment end 21 and a vehicle attachment end 29. At least one pivot 25 is provided such that the vehicle 100 and LIM 30 may be suspended or levitated independently of each other during operation without carrying the weight of the other. Pivot 25 may take a variety of embodiments, such as a ball pivot that permits relative motion in substantially all directions other than in the at least one desired direction. In another, simple embodiment, pivot 25 may be provided with member 20 in the form of a T-shaped bar with the transverse of the T-shape at the vehicle attachment end 29 riding in a vertical slot on vehicle 100 at a point corresponding to reaction rail 75. Of course, simpler embodiments may lead to greater wear of member 20, or a requirement for closer tolerances.

Optionally, member 20 may include or incorporate other elements. For example, in some embodiments, motor bus subsystem 37 may be incorporated into member 20 if elements, such as drive inverter 60, were to be positioned on vehicle 100. In another example, member 20 may include a shock absorbing system (not shown). In another example, member 20 may include additional pivots or structure providing additional degrees of freedom, such as ball joints at motor attachment end 21 and vehicle attachment end 29, as shown in FIG. 3. Optionally, member 20 may be detachably coupled to vehicle 100 at motor attachment end 21, vehicle attachment end 29, or some other desired location. Detachable coupling may permit separation for LIM 30 from vehicle 100, for reasons such as maintenance, towing a different vehicle, or other desired use.

Returning to FIG. 2, application of a current from power supply 77 to stator 35 via motor bus subsystem 37 creates a desired force along the at least one desired direction. LIM 30 may thus be used for acceleration, overcoming steady state resistance for operating a constant speed, or for braking.

LIM 30 may take a variety of characteristics. For example, FIG. 2 shows a circular reaction rail 75 with a LIM 30 having a wrap around, in facing, active stator 35 design, which can enable a very small gap for improved efficiency.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A system for propelling a vehicle in at least one desired direction, the vehicle being configured to levitate magnetically with respect to a levitation surface, the system comprising:
a linear induction motor situated proximate to, but off-board, the magnetic levitation vehicle, the motor comprising a stator defining a channel adapted to receive a supported reaction rail, the rail extending in the at least one desired direction, a motor suspension system adapted to suspend the stator at a desired distance from the reaction rail;
a motor bus subsystem in conductive communication with the linear induction motor, a power supply, and a control system;
a generally rigid member extending between the linear induction motor and the vehicle, the member having a motor attachment end affixed to the motor and a vehicle attachment end affixed to the vehicle, wherein the member includes at least one pivot such that the vehicle and the linear induction motor may be suspended independently of each other during operation without carrying the weight of the other;
wherein, application of a current to the stator of the linear induction motor via the motor bus subsystem creates a desired force along the at least one desired direction; and
wherein, the general rigidity of the member is such that the desired force along the at least one desired direction is communicated to the linear induction motor, the general rigid member, and the vehicle, such that they are propelled in the at least one desired direction.

2. The system of claim 1, wherein the motor suspension system comprises rollers.

3. The system of claim 1, wherein the motor suspension system comprises wheels.

4. The system of claim 1, wherein the motor suspension system comprises a secondary magnetic levitation system.

5. The system of claim 1, wherein the motor suspension system comprises an air cushion system.

6. The system of claim 1, wherein the member further comprises a shock absorber.

7. The system of claim 1, wherein the attachment ends of the member comprise ball joints.

8. The system of claim 1, wherein the motor attachment end is detachably affixed to the motor.

9. The system of claim 1, wherein the vehicle attachment end is detachably affixed to the vehicle.

10. The system of claim 1, wherein the power supply is located off-board the vehicle.

11. The system of claim 10, wherein the control system is located off-board the vehicle.

12. The system of claim 4, wherein the secondary magnetic levitation system comprises at least a portion of the stator.

13. The system of claim 1, wherein the control system and power supply are located on the vehicle.

14. A system for propelling a vehicle in at least one desired direction, the system comprising:
a linear induction motor situated proximate to, but off-board the vehicle, the motor comprising a stator defining a channel adapted to receive a supported reaction rail, the rail extending in the at least one desired direction, a motor suspension system adapted to suspend the stator at a desired distance from the reaction rail;
a motor bus subsystem in conductive communication with the linear induction motor, a control system, and a power supply;
a generally rigid member extending between the linear induction motor and the vehicle, the member having a motor attachment end affixed to the motor and a vehicle attachment end affixed to the vehicle, wherein the member includes at least one pivot such that the vehicle and the linear induction motor may be suspended independently of each other during operation without carrying the weight of the other;
wherein, application of a current to the stator of the linear induction motor via the motor bus subsystem creates a desired force along the at least one desired direction; and
wherein, the general rigidity of the member is such that the desired force along the at least one desired direction is communicated to the linear induction motor, the general rigid member, and the vehicle, such that they are propelled in the at least one desired direction.

15. The system of claim 14, wherein the motor suspension system comprises rollers.

16. The system of claim 14, wherein the motor suspension system comprises wheels.

17. The system of claim 14, wherein the motor suspension system comprises a motor magnetic levitation system.

18. The system of claim 14, wherein the motor suspension system comprises an air cushion system.

19. The system of claim 14, wherein the member further comprises a shock absorber.

20. The system of claim 14, wherein the attachment ends of the member comprise ball joints.

21. The system of claim 14, wherein the motor attachment end is detachably affixed to the motor.

22. The system of claim 14, wherein the vehicle attachment end is detachably affixed to the vehicle.

23. The system of claim 14, wherein the power supply is located off-board the vehicle.

24. The system of claim 23, wherein the control system is located off-board the vehicle.

25. The system of claim 17, wherein the motor magnetic levitation system comprises at least a portion of the stator.

26. The system of claim 14, wherein the control system and power supply are located on the vehicle.
